(19) United States
(12) Patent Application Publication
(10) Pub. No.: US 2010/0221842 A1
(43) Pub. Date: Sep. 2, 2010

(54) SENSOR DEVICE FOR THE DETECTION OF TARGET COMPONENTS

(75) Inventors: Derk J.W. Klumder, Eindhoven (NL); Albert H.J. Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/679,318

(22) PCT Filed: Sep. 24, 2008
(86) PCT No.: PCT/IB2008/053886

§ 371 Date: Mar. 22, 2010

(30) Foreign Application Priority Data
Sep. 28, 2007 (EP) 07301408.6

(51) Int. Cl. G01N 21/00; B01J 19/00

(52) U.S. Cl. 436/164; 422/82.05; 422/129

(57) ABSTRACT

There is provided a microelectronic sensor device for the detection of target components comprising label-particles, comprising a carrier with a binding surface at which target components can collect; a light source for emitting a light beam incident at the binding surface; a light detector for determining the amount of light in a reflected light beam. In one aspect of the invention, the binding surface is provided by a plurality of aperture defining structures having a smallest in plane aperture dimension (W1) smaller than a diffraction limit, the diffraction limit defined by a medium for containing the target components. Preferentially, the sensor device is used, wherein target components are non-luminescent.

### FIELD OF THE INVENTION

The invention relates to a microelectronic sensor device for the detection of target components.

### BACKGROUND OF THE INVENTION

In an inhomogeneous assay, the concentration of a targeted bio-molecule can be determined by measuring the surface concentration of the targeted bio-molecule or beads [that are representative for the targeted bio molecule] bound at the sensor surface. As an example, one can think of a competitive assay where the binding surface (substrate) is covered with target molecules. The beads may be covered with specific [for the target molecule] antibodies and are dispersed in a fluid that contains the target molecules. The free target molecule in the sample competes with the immobilized target molecule on the sensor surface for binding to the antibody-coated bead. In case of a low concentration, the chance that an antibody binds with a target molecule at the sensor surface is higher than the chance that an antibody binds with a target molecule in the solution. By measuring the surface concentration of beads that are bound at the substrate, one can determine the concentration of the target molecule. Accurate measurement of the concentration however requires a highly surface specific detection scheme that is sufficiently insensitive for beads in the solution.

Furthermore, the detected signal should be independent from the sample matrix, which can be whole-blood, whole-saliva, urine or any other biological fluid. For optical detection schemes high surface specificity can be achieved by reducing the measurement volume. One way to achieve this is by confocal imaging where the measurement volume is reduced to typically a few wavelengths (e.g., 1 micron). US 2005/0048599 A1 discloses a method for the investigation of microorganisms that are tagged with particles such that a (e.g. magnetic) force can be exerted on them. In one embodiment of this method, a light beam is directed through a transparent material to a surface where it is totally internally reflected. Light of this beam that leaves the transparent material as an evanescent wave is scattered by microorganisms and/or other components at the surface and then detected by a photodetector or used to illuminate the microorganisms for visual observation.

### SUMMARY OF THE INVENTION

A desire exists to provide a microelectronic sensor device for the detection of target components wherein the media for containing the target components are not limited to materials having a refractive index smaller than the carrier and the refractive index of the particles attached to the targeted components can be chosen above as well as below the refractive index of the carrier without significantly impacting the sensitivity, for example, to provide the sensor device for biosensing purposes. Accordingly, in one aspect of the invention, there is provided a microelectronic sensor device for the detection of target components, comprising a carrier with a binding surface at which target components can collect; a source for emitting a beam of radiation incident at the binding surface; a detector for determining an amount of said emitted radiation in a reflective mode. In one aspect of the invention, the binding surface is provided by a plurality of aperture defining structures having a smallest in plane aperture dimension W1 smaller than a diffraction limit, the diffraction limit defined by a medium for containing the target components.

In another aspect of the invention there is provided a method of detecting a presence of a target component in a medium, comprising: providing a binding surface at which target components can collect, by a plurality of aperture defining structures having a smallest in plane aperture dimension W1 smaller than a diffraction limit, the diffraction limit defined by a medium for containing the target components; emitting a beam of radiation incident on the binding surface, the binding surface formed by a plurality of aperture defining structures having a smallest in plane aperture dimension W1 smaller than a diffraction limit, the diffraction limit defined by a medium for containing the target components; and detecting an amount of said radiation in a reflective mode. These and other aspects of the invention will be apparent from and elucidated with reference to the embodiment(s) described hereinafter.

### BRIEF DESCRIPTION OF THE DRAWINGS

FIG. 1 shows a general setup of a microelectronic sensor device according to an aspect of the present invention;

FIG. 2 shows an illustrative schematic view of the binding surface depicted in FIG. 1;

FIG. 3 shows a simulated field distribution inside a wire grid polarizer with varying magnitude of the electric field;

FIG. 4 shows a first embodiment according to an aspect of the invention;

FIG. 5 shows an alternative setup, wherein an increased scattering due to presence of beads in the evanescent volume is measured;

FIG. 6 shows an improved scheme for detection of reduced reflection due to presence of a bead in space between the wires;

FIG. 7 shows an impact of the width of the slit on the sum of reflected diffractions orders, with index of medium that fills wire grid as parameter.

FIG. 8 shows the impact of index in the space between the wires on the fundamental reflection; and

FIG. 9 shows an impact of thickness layer with index 1.58 on fundamental (OR) reflection and the sum of the reflection and transmission (Total).

### DETAILED DESCRIPTION OF EMBODIMENTS

The microelectronic sensor device according to the present invention may serve for the qualitative or quantitative detection of target components, wherein the target components may for example be biological substances like biomolecules, complexes, cell fractions or cells. The term “label and/or particle” shall denote a particle (atom, molecule, complex, nanoparticle, microparticle etc.) that has some property (e.g. optical density, magnetic susceptibility, electrical charge.) which can be detected, thus indirectly revealing the presence of the associated target component. A “target component” and a “label particle” may be identical. The microelectronic sensor device, according to an aspect of the invention comprises the following components:
a) A carrier with a binding surface at which target components can collect.

The term “binding surface” is chosen here primarily as a unique reference to a particular part of the surface of the carrier, and though the target components will in many applications actually bind to said surface, this does not necessarily need to be the case. All that is required is that the target components can reach the binding surface to collect there (typically in concentrations determined by parameters associated to the target components, to their interaction with the binding surface, to their mobility and the like). The carrier should have a high transparency for light of a given spectral range, particularly light emitted by the light source that will be defined below. The carrier may for example be produced from glass or some transparent plastic. The carrier may be permeable; it provides a carrying function for aperture defining structures provided on the carrier having a smallest in plane aperture dimension (W1) smaller than a diffraction limit
b) A source for emitting a beam of radiation, called “incident light beam” in the following, into the aforementioned carrier such that it is reflected, at least in an investigation region at the binding surface of the carrier. The light source may for example be a laser or a light emitting diode (LED), optionally provided with some optics for shaping and directing the incident light beam. The “investigation region” may be a sub-region of the binding surface or comprise the complete binding surface; it will typically have the shape of a substantially circular spot that is illuminated by the incident light beam.
c) A detector for determining an amount of said emitted radiation in a reflective mode, wherein the term “reflected light beam” shall both be a reference to the light that is caught by the detector and imply that light of this beam stems from the aforementioned reflection of the incident light beam. It is however not necessary that the “reflected light beam” comprises all the reflected light, as some of this light may for example be used for other purposes or simply be lost. In addition, where in the application the term reflective mode is used, depending on context, this may encompass any type of radiation that is emitted from the source and that is reflected by the aperture defining structures, including scattering and specularly reflected diffraction type of reflection.
   The detector may comprise any suitable sensor or plurality of sensors by which light of a given spectrum can be detected, for example a photodiode, a photo resistor, a photocell, or a photo multiplier tube. Where in this specification the term light or radiation is used, it is meant to encompass all types of electromagnetic radiation, in particular, depending on context, as well visible as non visible electromagnetic radiation.
d) The binding surface of the sensor is provided with a plurality of aperture defining structures having a first smallest in plane aperture dimension (W1) smaller than a diffraction limit, the diffraction limit (Wmin) defined by a medium for containing the target components: by a:

Wmin=wavelength/(2*nmedium) (1)

with λ the wavelength in vacuum and n_{medium} the refractive index of the medium in front of the wire grid.

In a preferred embodiment, the aperture defining structure defines a first and a second in-plane vector that are parallel to a slab of material that is not transparent (examples are metals such as gold (Au), silver (Ag), chromium (Cr), aluminium (Al)). The first (smallest) in-plane aperture dimension is parallel to the first in-plane vector and the second (largest) in-plane aperture dimension is parallel to the second in-plane vector.

### Accordingly Two Types of Apertures can be Distinguished:

1 Apertures of the first-type with a first in-plane dimension W1 below the diffraction limit and a second in-plane dimension W2 above the diffraction limit there is a transmission plane that is composed of the first in-plane vector and a third vector that is normal to the first and second in-plane vectors. R-polarized incident light, that is light having an electric field orthogonal to the plane of transmission, is substantially reflected by the aperture defining structure and generates an evanescent field inside the aperture. T-polarized light incident on an aperture defining structure composed of apertures of the first type, that is light having an electric field parallel to the planes of transmission of the one or more apertures, is substantially transmitted by the aperture defining structure and generates a propagating field inside the aperture.

2 For apertures of the second-type with both in-plane dimensions below the diffraction limit we cannot define a plane of transmission. Incident light of any polarization (such as linearly, circularly, elliptically, randomly polarized) is substantially reflected by the aperture defining structure and generates an evanescent field inside the aperture.

The described microelectronic sensor device allows a sensitive and precise quantitative or qualitative detection of target components in an investigation region at the binding surface. This is due to the fact that the light beam, which is preferably R-polarized for apertures of the first type and may have any polarization for apertures of the second type, that is incident on the aperture defining structure generates an evanescent wave that extends from the end of the aperture adjacent to the carrier a short distance into the aperture. If light of this evanescent wave is scattered or absorbed by target components or label particles present at the binding surface, it will result in a reduction of the power/energy in specularly reflected light beam. The power/energy in the reflected light beam (more precisely the reduction of the power/energy in the reflected light beam due to the presence of target components or label particles present at the binding surface) is therefore an indication of the presence and the amount of target components/labels at the binding surface. One advantage of the described optical detection procedure comprises its accuracy as the evanescent waves explore only a small volume that extends typically 10 to 30 nm into the aperture from the end of the aperture adjacent to the carrier, thus avoiding disturbances (such as scattering, reflection) from the bulk material behind this volume. As the reduction of the specularly reflected light is caused by essentially only the target components or label particles present at the binding surface, a high sensitivity is achieved. Moreover, the optical detection can optionally be performed from a distance, i.e. without mechanical contact between the carrier and the light source or light detector.

The microelectronic sensor device may be used for a qualitative detection of target components, yielding for example a simple binary response with respect to a particular target molecule (“present” or “not-present”). Preferably the sensor device comprises however an evaluation module for quantitatively determining the amount of target components in the investigation region from the detected reflected light. This can for example be based on the fact that the amount of light in an evanescent light wave, that is absorbed or scattered by target components, is proportional to the concentration of these target components in the investigation region. The amount of target components in the investigation region may in turn be indicative of the concentration of these components in a sample fluid that is in communication with the aperture according to the kinetics of the related binding processes.

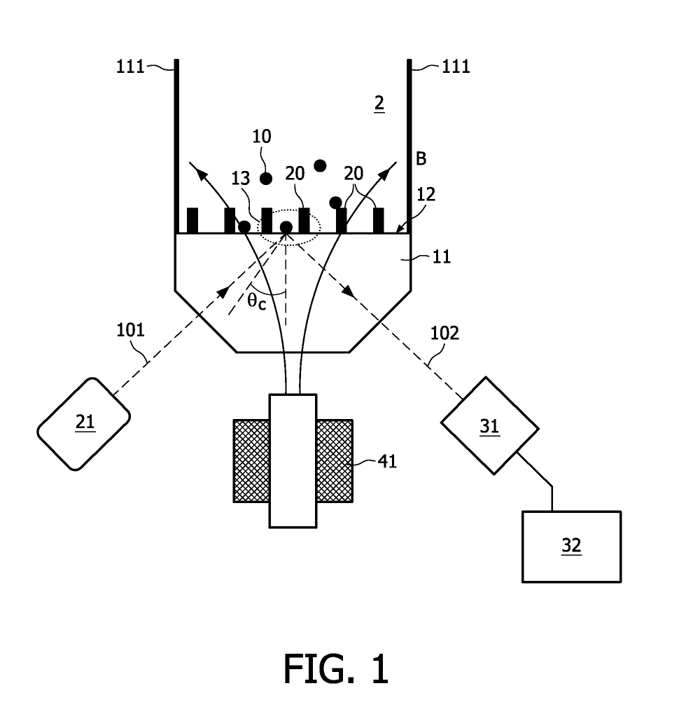

Turning to FIG. 1 a general setup is shown of a microelectronic sensor device according to an aspect of the present invention. A central component of this device is the carrier 11 that may for example be made from glass or transparent plastic like poly-styrene. The carrier 11 is located next to a sample chamber 2 in which a sample fluid with target components to be detected (e.g. drugs, antibodies, DNA, etc.) can be provided. Chamber 2 may in addition be defined by upstanding walls 111 that, in a preferred embodiment, are repeated continuously to form a plurality of adjacent walls 111, forming a well-plate for example, for microbiological assays. The sample further comprises magnetic particles 1, for example superparamagnetic beads, wherein these particles 10 are usually functionalized with binding sites (e.g., antibodies) for specific binding of aforementioned target components (for simplicity only the magnetic particles 1 are shown in the Figure). It should be noted that instead of magnetic particles other label particles, for example electrically charged or fluorescent particles, could be used as well.

The interface between the carrier 11 and the sample chamber 2 is formed by a surface called “binding surface” 12. This binding surface 12 may optionally be functionalized or coated with capture elements, e.g. antibodies, ligands, which can specifically bind the target components.

It is reminded here that a functionalized surface or particle is referred to as a surface or particle whereon capture elements, e.g. antibodies, ligands, which can specifically bind the target components are immobilized.

The sensor device may optionally comprise a magnetic field generator 41, for example an electromagnet with a coil and a core, for controllably generating a magnetic field B at the binding surface 12 and in the adjacent space of the sample chamber 2. With the help of this magnetic field B, the magnetic particles 10 can be manipulated, i.e. be magnetized and particularly be moved (if magnetic fields with gradients are used). Thus it is for example possible to attract magnetic particles 10 to the binding surface 12 in order to accelerate the binding of the associated target component to said surface.

The sensor device further comprises a light source 21, for example a laser or a LED, that generates an incident light beam 101 which is transmitted into the carrier 11. The incident light beam 101 arrives at the binding surface 12 and is reflected as a “reflected light beam” 102. The reflected light beam 102 leaves the carrier 11 and is detected by a light detector 31, e.g. a photodiode. The light detector 31 determines the power/energy of the reflected light beam 102 (e.g. expressed by the light intensity of this light beam in the whole spectrum or a certain part of the spectrum). The measurement results are evaluated and optionally monitored over an observation period by an evaluation and recording module 32 that is coupled to the detector 31. On the carrier surface 12, a slab of material that is not transparent, preferably metal (for example gold (Au), silver (Ag), chromium (Cr), aluminium (Al)) is provided in the form of strips 20, defining a wire grid having a smallest in plane aperture dimension (W1) smaller than a diffraction limit, the diffraction limit defined by the ratio between wavelength and twice the refractive index of the medium 2 containing the target components 10. The angle of incidence θ can in principle vary from 0 to 90°. Due to the diffraction limited nature of the aperture, in investigation area 13 an evanescent field is created that may be selectively disturbed due to the presence of particles that are bound by carrier surface 12 or at least within reach of the evanescent field generated by the aperture defining structures 20.

The described microelectronic sensor device applies optical means for the detection of particles 10 and the target components one is actually interested in. For eliminating or at least minimizing the influence of background (e.g. of the sample fluid, such as saliva, blood, etc.), the detection technique should be surface-specific. The use of magnetic labels in a wiregrid biosensor has the advantage (compared to the use of non-magnetic labels) that magnetic actuation can be applied for various reasons:

upconcentration of target molecules near the surface (catch assay) to improve assay speed and detection limit.

magnetic washing for stringency (instead of more complex and less-reproducible fluid washing).

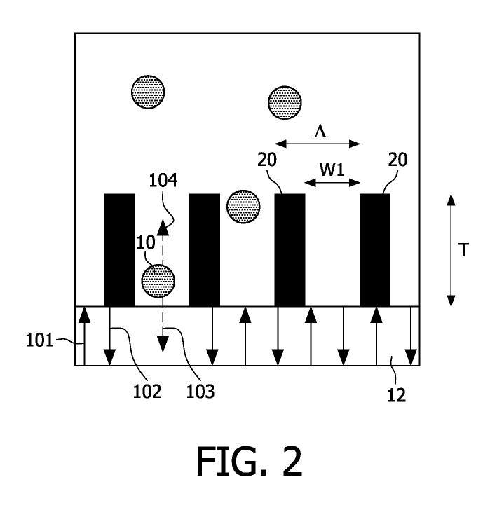

In FIG. 2 an illustrative schematic view is shown of the binding surface 12 depicted in FIG. 1. It shows that the surface is provided with a plurality of aperture defining structures 20. In particular, in the shown embodiment, these structures can be provided by metal wires or strips 20, defining apertures W1 of the above mentioned first-type with a second in-plane dimension W2 substantially above the diffraction limit. Typically, these strips are formed as a periodic structure of elongated parallel wires 2 attached to a carrier body 11. Such a structure is typically referenced as a wire grid. Although the invention can be applied in a periodic structure (grating structure), this is not necessary, indeed the structure may also be aperiodic or quasi periodic. The aperture dimension W1 of the smallest dimension, or, if applicable, a grating period A, is typically smaller than the diffraction limit, the diffraction limit defined by a principal wavelength or band of wavelengths of the incident light beam and a medium for containing the target components. Preferably, the incident light beam is exclusively comprised of radiation having wavelengths above the diffraction limit. A nice property of aperture defining structures with apertures of the first-type such as the wire-grid technology is that the light inside the aperture can be switched from an evanescent mode to a propagating mode quite easily by switching the polarization of the input light, which enables both surface specific and bulk measurements.

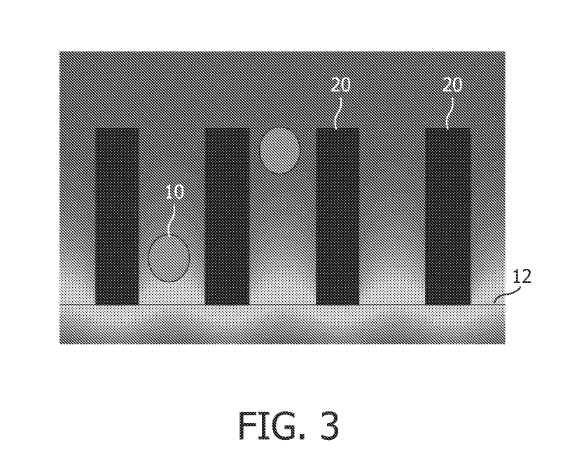

In FIG. 2, the transmission plane is parallel to the plane of the paper, R-polarized polarized (electric field directed out of the plane of the paper) incident light (101) results in an evanescent field in the space between the wires of the wire grid and a substantial amount of reflected light (102). From the simulated field distribution, in FIG. 3, it can be seen that only bead (10) is within the range of the evanescent field resulting in a reduction of the specular reflection (103) due to an increased transmission (104) or scattering of the evanescent field. By measuring the (reduction in) reflected light or the scattering due to the presence of a bead within the evanescent field, one can determine the concentration of beads with a high surface specificity.

Typical bead sizes are in the order of 10-1000 nm. Typical parameters for a wire grid made of Aluminium used for red excitation light (e.g., HeNe laser having a wavelength of 632.8 nm) are a period of 140 nm (59% of the diffraction limit in water for this wavelength); duty cycle of 50% and a height of 160 nm. For these parameters, the (1/e) intensity decay length in an aperture filled with water is only 17 nm. The maximum bead size (i.e., beads that ‘just’ fit in the space between the wires) is limited to somewhat smaller than 70 nm for these parameters. For an aperture of the first type, a preferred value for the first in-plane dimension W1 is less than 50% of the diffraction limit or less than 119 nm (for a wavelength of 632.8 nm and an aperture filled with water), more preferred the first in-plane dimension W1 is less than 40% of the diffraction limit or less than 95 nm (for a wavelength of 632.8 nm and an aperture filled with water), and most preferred the first in plane dimension W1 is less than 30% of the diffraction limit or less than 71 nm (for a wavelength of 632.8 nm and an aperture filled with water). A preferred value for the second in plane dimension W2 is at least the diffraction limit or at least 238 nm (for a wavelength of 632.8 nm and an aperture filled with water), more preferred the second in plane dimension W2 is 20 to 200 times the diffraction limit or 4.8 to 48 μm (for a wavelength of 632.8 nm and an aperture filled with water), even more preferred the second in plane dimension W2 is 200 to 2000 times the diffraction limit or 48 to 480 μm (for a wavelength of 632.8 nm and an aperture filled with water), and most preferred the second in plane dimension W2 is at least 200 times the diffraction limit or 480 μm (for a wavelength of 632.8 nm and an aperture filled with water).

As an example consider the case of beads with a diameter of 200 nm. For this diameter, a period of 580 nm and a duty cycle of ⅔ is a reasonable choice; opening between the wires of 387 nm. In order to avoid propagating diffraction orders for the transmitted light, the grating period should be below the diffraction limit in water (index of refraction of 1.33): for a period of 580 nm, this implies that the wavelength of the incident light is at least 1540 nm. For a wavelength of 1600 nm and a thickness of 600 nm, this results in an (1/e) intensity decay length of 109 nm and a background suppression (for the bulk on top of the wire grid) of 250.

In FIG. 3 a simulated intensity distribution inside a wire grid polarizer is shown with the spheres 10 indicating beads in between and on top of the wires 20 provided on carrier surface 12.

Preferably, beads are used with a polymer matrix containing small superparamagnetic grains (e.g. Iron oxide). The index of the beads should be different from the index of the fluid that fills the wires (which is typically water).

A rough estimate for the impact of a bead between the wires on the transmission and reflection of the wire grid samples can be obtained from calculating the impact of filling the space between the wires with a higher index material on the intensity decay. The (1/e) intensity decay length increases from 125 nm for a wire grid filled with SiO2 (index of 1.45) up to 1550 nm for a wire grid filled with Si3N4 (index of 2). If we assume that beads with a diameter of 200 nm can be represented by a uniform layer having a thickness of 100 nm, we find an increase in the transmission by the wire grid—assuming no additional reflections due to index mismatch between the bead and its environment—of 12% and 235% respectively.

The wiregrids 20 have a period (Λ) and define an aperture W1 and thickness T.

For good reflection the opening between the sections of material is preferably below 80% of the diffraction limited opening. The diffraction limited wavelength for an aperture may typically be defined as a wavelength in the medium inside the aperture equal to twice the smallest aperture dimension W1. Typically, the efficiency varies between 0.98 for zero degree incidence, to almost 1 for 90 degree incidence (relative to a normal of a plane of incidence). As an alternative the wiregrids 20 may be replaced by an array of 2D sub-diffraction limited apertures, also referenced as a pin-hole structure. In this case the aperture defining structures is composed of apertures of the second-type mentioned here above. Accordingly these arrays have a high reflection (and evanescent fields inside the apertures) for any polarization.

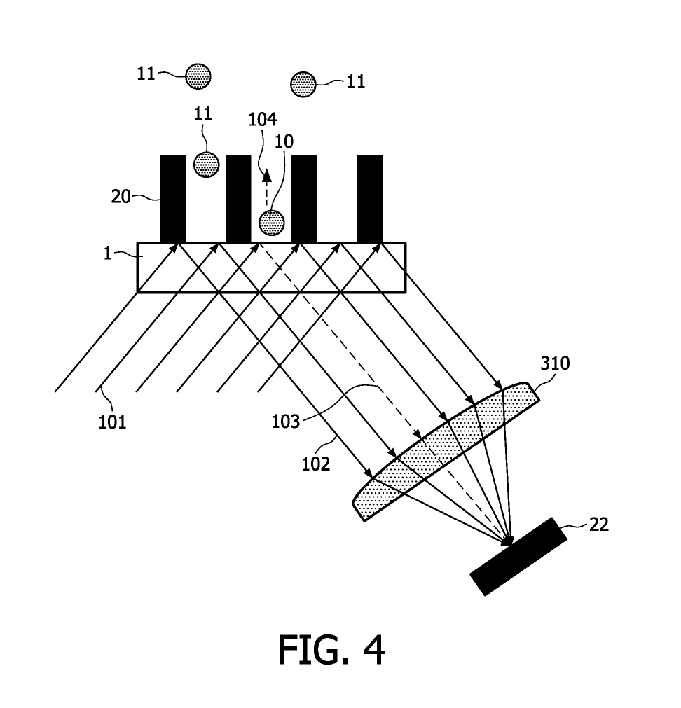

FIG. 4 shows a first embodiment according to an aspect of the invention, wherein a direct measurement is performed of a changed reflection of the incident beam due to the presence of beads (10, 11) in the evanescent volume. Accordingly a changed reflection due to the presence of beads (10) in the evanescent volume is measured. The presence of a bead (10) within the evanescent volume in between the wires of the wire grid (20), results in a reduced reflection for a bead with an index of refraction higher than the index of refraction of the fluid 3 and an increased reflection for a bead with an index of refraction higher than the index of refraction of the fluid 3, in case of no scattering by the bead/particle. The high refractive index of the bead [than the fluid], results in locally less steep decay of the evanescent field and as a result in an increased transmission (104) and reduced (103) reflection. The reflected light (102,103) is imaged on a detector/CCD (22) by a lens (310). Typically, a comparator (not shown) will be arranged in the detector to compare a detected light beam with a reference beam to measure a reduction of reflected light to indicate a presence of a target component.

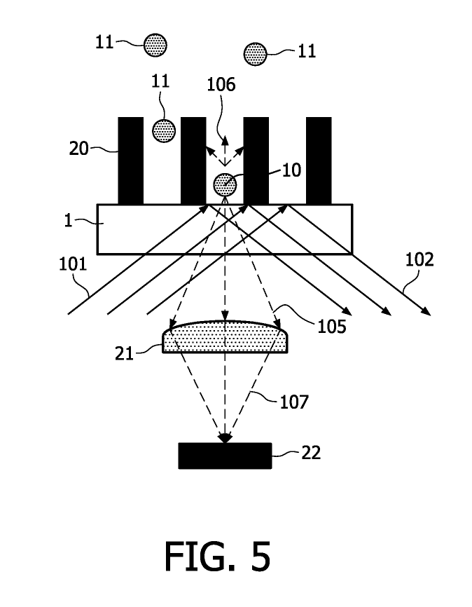

FIG. 5 shows an alternative setup, wherein an increased scattering due to presence of beads in the evanescent volume is measured. In this embodiment the detector 22 is arranged to detect a scattered beam 105. The scattered beam 105 is imaged through lens 21 on detector surface 22 and is accordingly separated from specularly reflected light beam (102) to indicate a presence of a target component (10). In particular, a presence of the bead (10) in the evanescent field results in scattering (105, 106). In particular, by orienting the detection opening (22) away from the specularly reflected beam (102), the reflected light is spatially separated from the scattered light (105), by illuminating the wire grid under an angle larger than the Numerical Aperture (NA) of the imaging lens (21).

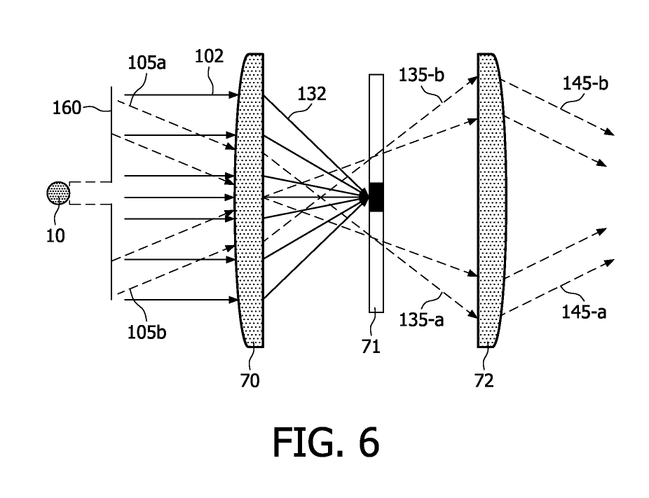

FIG. 6 shows an improved scheme for detection of reduced reflection due to presence of a bead/particle (10) the in space between the wires. The presence of the bead/particle (10) results in a local decrease of the reflection. This is illustrated in FIG. 6, where the local reduction in the reflection results intensity profile (160) for the reflected light. Using a Fourier optics approach, one can filter out the contribution in the reflected signal in case of no beads in the space between the wires. This is illustrated in FIG. 6, by using a pair of lenses (70, 72) with a mask (71) in the focal plane of the first lens (70). The signal contribution in case of no beads in the space between the wires and a plane wave input is a plane wave that propagates in the direction parallel to the optical axis of the system and hence the DC component in the spatial frequency spectrum. This DC component 102 is imaged on the optical axis by a first lens (70) and the resultant refracted beam 132 is blocked by a mask (71). The higher spatial frequency components (illustrated by beams (105-a,b) that propagate under an angle with respect to the optical axis are transmitted and are refracted as beams 135a and 135b to be focused at positions behind the first lens away from the optical axis. The second lens (72) is used for retrieving the plane waves (145-a,b) that propagate under an angle with respect to the optical axis.

A disadvantage of the arrangement of embodiment of FIG. 4 is that it requires the measurement of a small decrease in the reflected signal (which is by itself a large signal). By positioning the lens system 70, 72 of the embodiment depicted in FIG. 6 in front of lens (21) in the embodiment depicted in FIG. 4, one can filter away the baseline reflection signal in case of no beads. As a result, one can use the complete dynamic range of the detector for measuring the reduction of the reflected signal. Note that an optical system with high NA is preferable to collect as much light as possible.

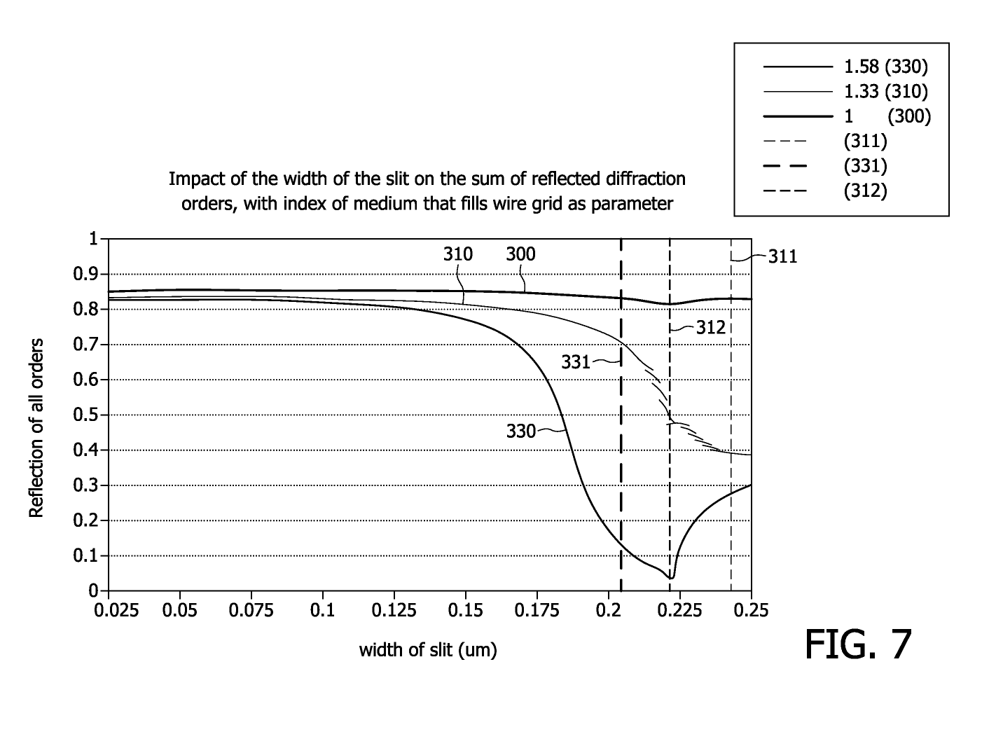

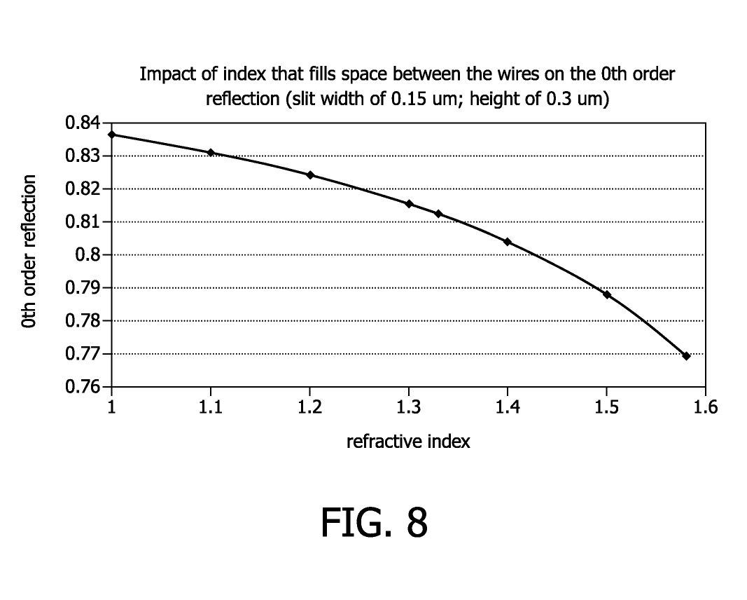

FIG. 7 shows an impact of the width of the slit on the sum of reflected diffractions orders for a wavelength of 650, with index of medium air (300) resp water(310) and a highly refractive medium (330) that fills wire grid as parameter. In particular, it is shown that there is a strong dependence of the reflection on the index of refraction that fills the slits. Preferably, the width of the slit is well below the diffraction limit (312) of the materials where the wire grid is composed the diffraction limit (311) for water or diffraction limit 331 of a refractive medium (330) that fills the slits 20 and on top of the slits. For the case considered here, this implies a width of the slit<246 nm. A good choice for the width of the slit is a width of 150 nm, which is well below (61% of the diffraction limit (311) in water (310)) the diffraction limits of the materials involved and changing the index of refraction of the material inside the slits results in a reasonable change in the reflection; reflection changes from 77% for medium (330) with an index of 1.58 filling the slits to 84% for air (300) inside and on top of the slits (see FIG. 8).

FIG. 8 shows the impact of index in the space between the wires (with water on top of the wire grids) on the specular reflection. Here it is assumed that a wire grid aperture width is 150 nm, and a slit height of 300 nm. In order to estimate the impact of the presence of a bead on the substrate, a bead on the substrate is modelled as a uniform layer inside the slits with a height equal to the height of the bead. Even though this is an oversimplification, where a scattering effect is ignored due to the presence of a particle rather than a uniform layer, the results give a reasonable indication of the impact of a bead in between the wires on the reflection and transmission of a wire grid which, in the present case, for a specular reflection may vary between 0.82 (refractive index 1) and 0.77 (refractive index 1.58). The figure illustrates that, the index of refraction of the target component or bead, which is in general a complex number having a real part N and an imaginary part K, should differ from the index of refraction of the fluid or medium wherein the target component is contained, to provide a detectable contrast. Typical ranges may be a difference in real part of 0.1 (for instance: water having a real part of the refractive index N=1.33 and the bead having a refractive index that differs 0.1 from the refractive index). Additionally, the contrasting effect may be provided by a difference in the imaginary part K, typically having a difference of 1.

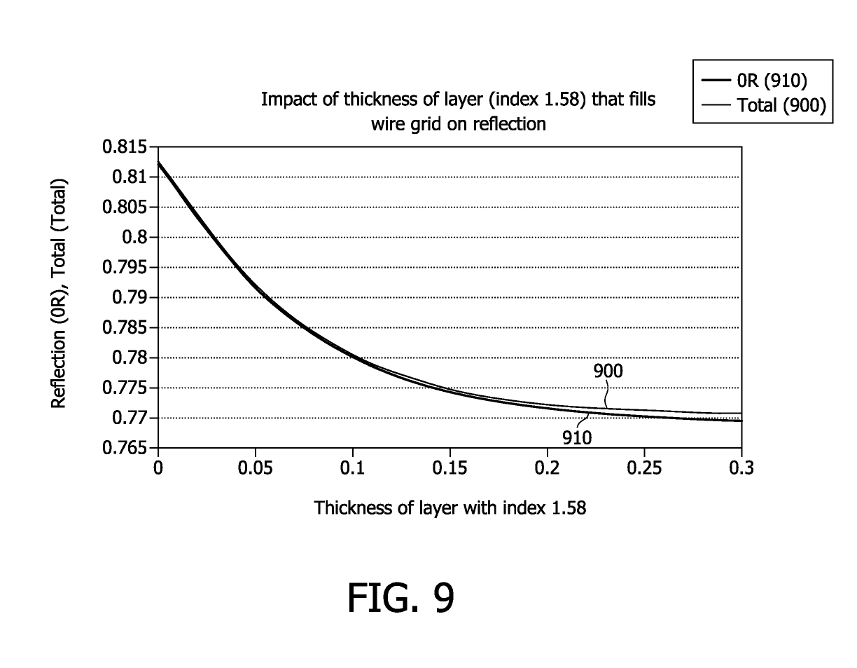

FIG. 9 shows an impact of thickness layer with index 1.58 on specular (OR) reflection (line 900) and the sum of the reflection and transmission (Total) (line 910). It can be seen that increasing the thickness of the layer with index 1.58 (representing a polystyrene bead with a diameter equal to the thickness of the layer) results in a decrease of the fundamental (0th order) reflection. This decrease is especially pronounced for thicknesses smaller than 50 nm, which is to be expected as the penetration depth of the evanescent field is 39 nm. The curve for the sum of the reflected and transmitted orders overlaps reasonably well with curve for the fundamental reflection, which is an indication that the decrease in reflection results in an increase in the losses (absorption by the metal wires of the wire grid) rather than an increase in the transmission.

Advantages of the described optical read-out combined with magnetic labels for actuation are the following:
Cheap cartridge: The carrier cartridge 11 can consist of a relatively simple, injection-molded piece of polymer material that may also contain fluidic channels.
Large multiplexing possibilities for multi-analyte testing: The binding surface 12 in a disposable cartridge can be optically scanned over a large area. Alternatively, large-area imaging is possible allowing a large detection array. Such an array (located on an optical transparent surface) can be made by e.g. ink-jet printing of different binding molecules on the optical surface.
   The method also enables high-throughput testing in well-plates by using multiple beams and multiple detectors and multiple actuation magnets (either mechanically moved or electro-magnetically actuated).
Actuation and sensing are orthogonal: Magnetic actuation of the magnetic particles (by large magnetic fields and magnetic field gradients) does not influence the sensing process. The optical method therefore allows a continuous monitoring of the signal during actuation. This provides a lot of insights into the assay process and it allows easy kinetic detection methods based on signal slopes.
The system is really surface sensitive due to the exponentially decreasing evanescent field.
Easy interface: No electrical interconnect between cartridge and reader is necessary. An optical window is the only requirement to probe the cartridge. A contact-less read-out can therefore be performed.
Low-noise read-out is possible.

In the environment of a laboratory, well-plates are typically used that comprise an array of many sample chambers (“wells”) in which different tests can take place in parallel. The production of these (disposable) wells is very simple and cheap as a single injection-moulding step is sufficient.

While the invention has been illustrated and described in detail in the drawings and foregoing description, such illustration and description are to be considered illustrative or exemplary and not restrictive; the invention is not limited to the disclosed embodiments.

In one example, other adjacent media are used, in particular, of a refractive index smaller than the carrier medium 12. It is noted that the generation of an evanescent field is also possible using total internal reflection. Depending on the index of refraction nglass for the glass prism, the angle of incidence θA in the carrier, and the wavelength λ of the used light, the magnitude of evanescent field can be described as:

exp(−k\sqrt{n_{glass}²sin²(θ_{A})−n_{fluid}²}·z)

with z the distance from the interface and k the wavenumber (2π/λ). The penetration depth into water ((1/e) intensity) ranges from 100 nm for silica (index of refraction 1.45) down to 35 nm for a high index glass (index of refraction 2) at a beam angle of 80 degrees with respect to the normal of the detection surface. Here it is assumed that the sample matrix has refractive index nfluid=1.33 (similar to water) and that the wavelength of the used light is 650 nm (DVD laser). However, in the context of total internal reflection, the desired reduction in the specular reflection due to the presence of a bead at the interface between the carrier and the sample matrix sets a minimum for refractive index of bead:

n_{bead}≧n_{glass}·sin(α) (1)

which implies that there is a minimum value for the refractive index of the bead. In particular, for most practical applications the penetration of the evanescent field into the sample matrix (1003) on top of the carrier is preferably limited to particles bound to the substrate. The penetration depth t_{decay (}1/e intensity of the evanescent field) depends on the refractive index of the prism (nglass) and the sample matrix (nfluid) and the angle of incidence (α):

t_{decay}=λ/(4·π·√[(n_{glass}·sin(α))²−n_{fluid}²]) (2)

By combining (1) and (2), one finds a criterion for the refractive index of the bead for a given penetration depth of the evanescent field:

$${n}_{bead}^{2} - {n}_{fluid}^{2} \geq {( \frac{λ}{4 π \cdot {t}_{decay}} )}^{2} \qquad ( 3 )$$

In addition, in the context of total internal reflection, the penetration depth into the medium is limited by choice of the carrier material and the medium for containing the target components.

A suitable decay length of for instance 30 nm requires an index of the prism of at least 1.87. Preferably the prisms for total internal reflection are made of low-cost material such as Polystyrene and Polycarbonate, with typical refractive indexes of 1.55 and 1.58 respectively. These materials limit the penetration depth in water to a minimum of 65 nm and 60 nm respectively.

In addition, total internal reflection requires grazing incidence. Also, the decay length depends on the angle of incidence. For a Polycarbonate prism, an angle of incidence of 60 degrees results in a penetration depth of 504 nm. The present invention, using the generation of evanescent fields by a plurality of aperture defining structures having a smallest in plane aperture dimension W1 smaller than a diffraction limit mitigates the limitations of the total internal reflection arrangement.

While the invention was described above with reference to particular embodiments, various modifications and extensions are possible, for example:

In addition to molecular assays, also larger moieties can be detected with sensor devices according to the invention, e.g. cells, viruses, or fractions of cells or viruses, tissue extract, etc.

The detection can occur with or without scanning of the sensor element with respect to the sensor surface.

Measurement data can be derived as an end-point measurement, as well as by recording signals kinetically or intermittently.

The particles serving as labels can be detected directly by the sensing method. As well, the particles can be further processed prior to detection. An example of further processing is that materials are added or that the (bio)chemical or physical properties of the label are modified to facilitate detection.

The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink-jet printing on the optical substrate.

The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).

The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.

Other variations to the disclosed embodiments can be understood and effected by those skilled in the art in practicing the claimed invention, from a study of the drawings, the disclosure, and the appended claims. Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic sensor device for the detection of target components, comprising
a carrier with a binding surface at which target components can collect;
a source for emitting a beam of radiation having a wavelength incident at the binding surface;
a detector for determining an amount of said emitted radiation in a reflective mode; wherein
the binding surface is provided with a plurality of aperture defining structures having a smallest in plane aperture dimension (W1) smaller than a diffraction limit, the diffraction limit defined by the radiation wavelength and a medium for containing the target components.

2. The microelectronic sensor device according to claim 1, wherein said aperture defining structures define a largest in plane aperture dimension W2;
wherein said largest in plane aperture dimension is larger than the diffraction limit.

3. The microelectronic sensor device according to claim 1, wherein said aperture defining structures comprise a non-transparant medium provided on the carrier.

4. The microelectronic sensor device according to claim 1, wherein the target components are non-luminiscent.

5. The microelectronic sensor device according to claim 1, further comprising a field generator for generating a magnetic field (B) and/or an electrical field that can affect the label particles.

6. A microelectronic sensor device according to claim 1, wherein the target components define an index of refraction different from the medium index of refraction

7. The microelectronic sensor device according to claim 1, further comprising a sample chamber adjacent to the binding surface in which a sample with target components can be provided that is in communication with said aperture.

8. The microelectronic sensor device according to claim 1, further comprising an evaluation module for determining the amount of target components in the investigation region from the light beam measured in a reflective mode.

9. The microelectronic sensor device according to claim 1, further comprising a recording module for monitoring the determined amount light in a reflective mode over an observation period.

10. The microelectronic sensor device according to claim 1, wherein the detector for determining an amount of said emitted radiation in a reflective mode comprises a comparator to compare a detected light beam with a reference beam to measure a reduction of reflected light to indicate a presence of a target component.

11. The microelectronic sensor device according to claim 1, wherein the detector is arranged to detect a scattered beam separated from a diffracted light beam to indicate a presence of a target component.

12. The microelectronic sensor device according to claim 12, wherein the detector comprises a mask to filter a DC component in the spatial frequency spectrum of a detected light beam.

13. A well-plate comprising a plurality of carriers according to claim 12.

14. A method of detecting a presence of a target component in a medium, comprising:
providing a binding surface at which target components can collect, by a plurality of aperture defining structures having a smallest in plane aperture dimension (W1) smaller than a diffraction limit, the diffraction limit defined by a medium for containing the target components;
emitting a beam of radiation incident on the binding surface, the binding surface formed by a plurality of aperture defining structures having a smallest in plane aperture dimension (W1) smaller than a diffraction limit, the diffraction limit defined by a medium for containing the target components; and
detecting an amount of said radiation in a reflective mode.

15. A method according to claim 14, wherein said target component is arranged to bind with a biomolecule.
